(19) United States
(12) Patent Application Publication
(10) Pub. No.: US 2007/0204655 A1
(43) Pub. Date: Sep. 6, 2007

(54) Method of manufacturing optical glass element

(75) Inventor: Kinya Kato, Osaka (JP)

Correspondence Address: BRINKS HOFER GILSON & LIONE, P.O. BOX 10395, CHICAGO, IL, 60610, US

(73) Assignee: KONICA MINOLTA OPTO, INC.

(21) Appl. No.: 11/712,134

(22) Filed: Feb. 28, 2007

(30) Foreign Application Priority Data
Mar. 2, 2006 (JP) 2006/56104

(51) Int. Cl. C03B 23/00; C03B 23/04; C03B 29/00

(52) U.S. Cl. 65/102; 65/286; 65/292

(57) ABSTRACT

A pair of upper die and lower die having forming surfaces corresponding to optical glass elements are prepared. A locating member having a plurality of locating holes for locating preforms is arranged on the lower die. A plurality of preforms are supplied to the locating holes, respectively, and the preforms are hot-press-molded between the paired upper die and lower die. According to this method, since a plurality of optical glass elements can be formed simultaneously, the high-precision optical glass elements can be manufactured at low cost.

The present application claims priority to Japanese Patent Application No. 2006-56104 filed Mar. 2, 2006, the entire content of which is hereby incorporated by reference.

### BACKGROUND OF THE INVENTION

1. Field of the Invention

The present invention relates to an optical glass element forming method of forming a plurality of optical glass elements at a time between an upper die and a lower die.

2. Description of the Related Art

Very high-precision optical glass elements are fabricated by a reheating press molding method using a preform, but since the temperature of dies should be increased or decreased at the time of the press molding, production efficiency is not always high. In order to heighten the production efficiency, therefore, it is considered that plural pairs of upper dies and lower dies are mounted to one mold, and a plurality of optical glass elements is press molded simultaneously (for example, see U.S. Pat. No. 5,417,730 and Japanese Patent Application Laid-Open No. 7-33452).

For example, as shown in FIG. 1A, a single-cavity die set 101 which is composed of an upper die 110, a lower die 120 and a sleeve 130 is prepared. The single-cavity die sets 101 where a preform 140 is mounted between the upper die 110 and the lower die is prepared, they are mounted to a lotus root-shaped member 160 having a plurality of die set mounting holes, respectively, shown in FIG. 1B, and a plurality of optical glass elements 5050 are formed at one forming process.

Since the above-mentioned plural-piece forming method using the lotus root-shaped member requires a lot of the die sets 101, the production cost becomes high, and the number of the die sets 101.capable of being arranged in the lotus root-shaped member 160 is limited.

As shown in FIG. 2, the preform 140 of larger size is prepared, and the preform 140 is press molded between the upper die 110 and the lower die 120 having a plural-cavity forming surface, and a formed block 150 obtained by the press molding is cut into some small pieces at a post-processing step, thereby obtaining optical glass elements 5050.

Since the post-cutting forming method requires the step of cutting the formed block 150 into small pieces, the production cost becomes high (particularly, in the case where a post-process into a circular shape is required, the production cost becomes extremely high). Further, since an applying pressure in the formed block 150 differs between both ends as opened portions and a center portion as an unopened portion, forming irregularity occurs.

### SUMMARY OF THE INVENTION

It is a main object of the present invention to provide a method and an apparatus which can manufacture high-precision optical glass elements at less cost.

In order to achieve this object and the other objects, a certain aspect of the present invention provides a method of hot-press-molding a preform between a pair of an upper die and a lower die so as to manufacture an optical glass element, includes the steps of:

arranging a locating member having a plurality of locating holes for locating the preform on the lower die;

supplying the preforms to the locating holes, respectively; and

hot-press-molding the preform between the paired upper die and the lower die.

Another aspect of the present invention provides an optical glass element manufacturing apparatus, comprising:

a lower die;

a locating member which has a plurality of locating holes for locating preforms and is arranged on the lower die; and

an upper die which hot-press-molds the preforms between the lower die between the lower die and the upper die.

The invention itself, together with further objects and attendant advantages, will best be understood by reference to the following detailed description taken in conjunction with the accompanying drawings.

### BRIEF DESCRIPTION OF THE DRAWINGS

FIGS. 1A and 1B are schematic views explaining an optical glass element forming method according to a conventional technique: FIG. 1A is the schematic view explaining the forming method using a single-cavity die set, and FIG. 1B is the schematic view explaining a plural-piece forming method using the single-cavity die set;

FIG. 2 is a schematic view explaining the optical glass element forming method according to a conventional technique;

FIG. 3 is a schematic view explaining the optical glass element forming method according to one embodiment of the present invention;

FIG. 4 is a sectional view schematically illustrating a state just before forming in the forming method in FIG. 3;

FIG. 5 is a perspective view schematically explaining a die in the forming method in FIG. 3 according to another embodiment;

FIGS. 6A and 6B are diagrams illustrating an optical glass element obtained by the forming method shown in FIG. 3: FIG. 6A is a plan view of the optical glass element, and FIG. 6B is a side view of the optical glass element; and

FIG. 7 is a diagram explaining a modified example of the present invention.

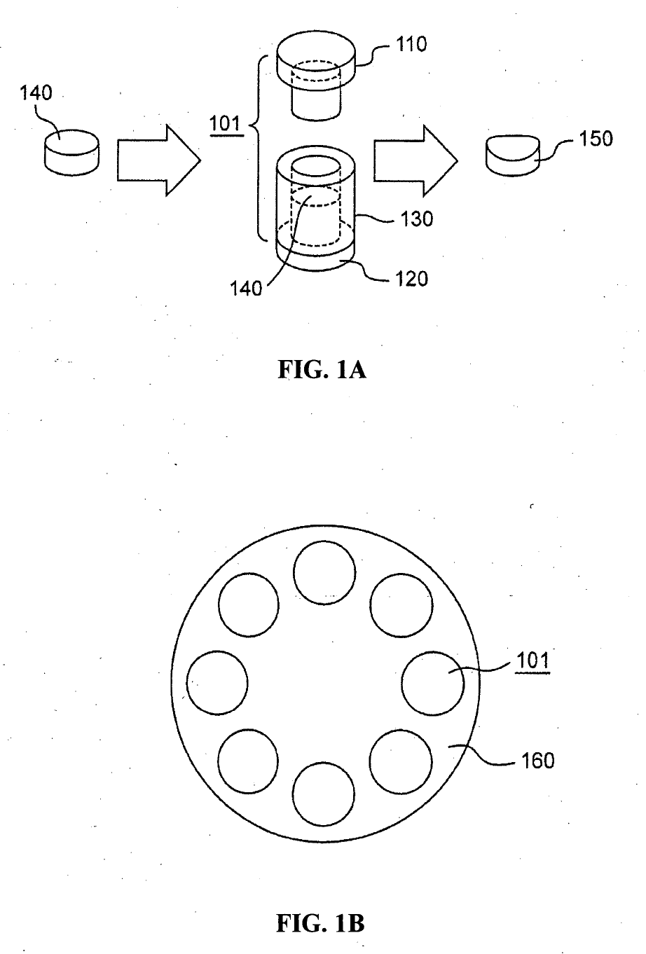

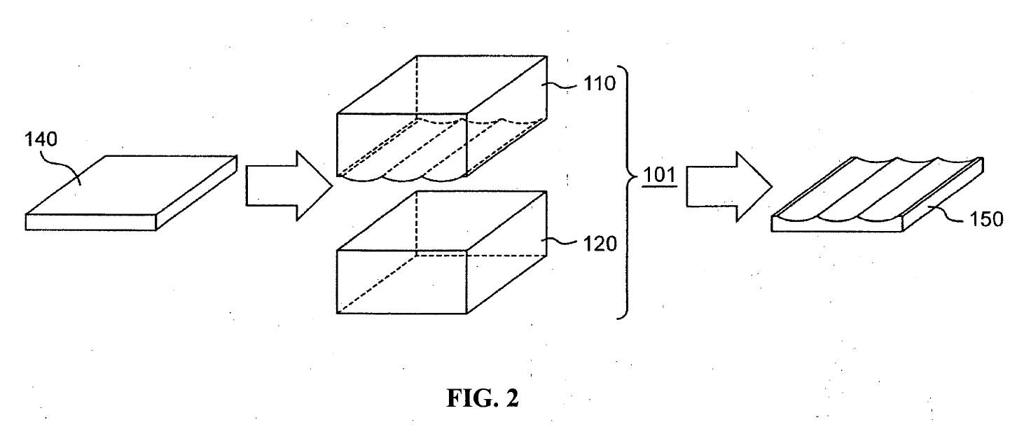

In the following description, like parts are designated by like reference numbers throughout the several drawing.

### DETAILED DESCRIPTION OF THE PREFERRED EMBODIMENTS

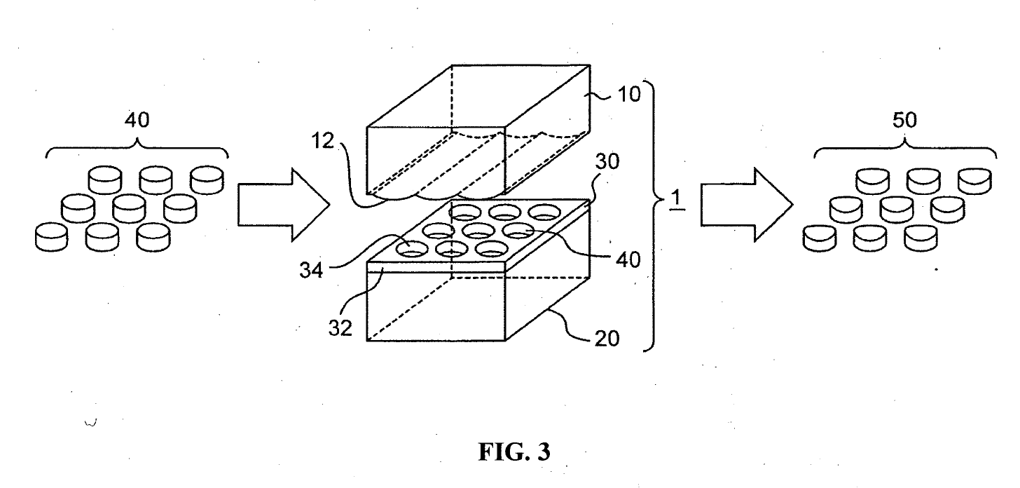

A forming method for an optical glass element 50 according to one embodiment of the present invention is explained in detail below with reference to FIGS. 3 to 6.

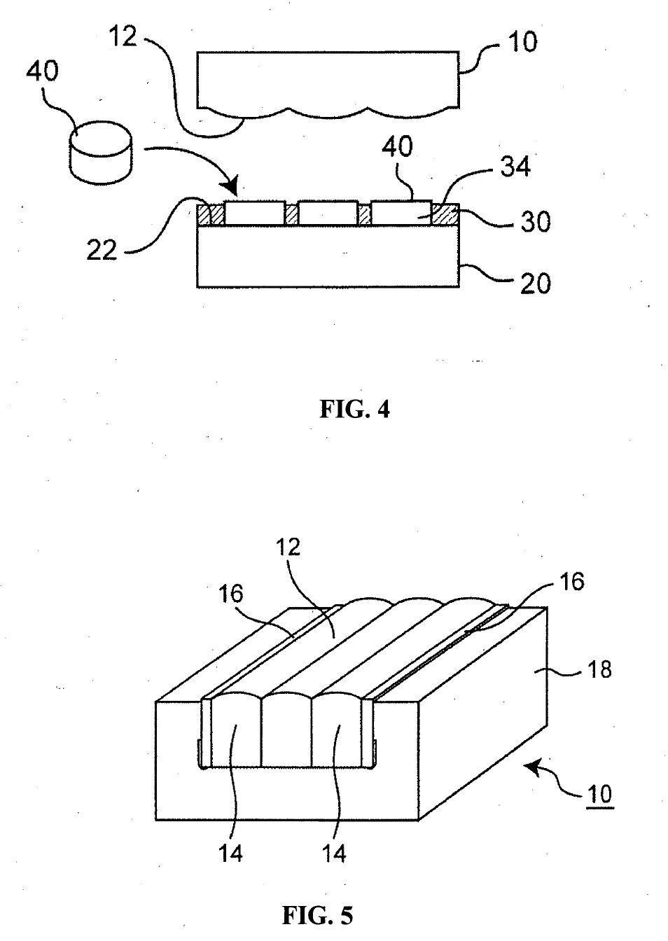

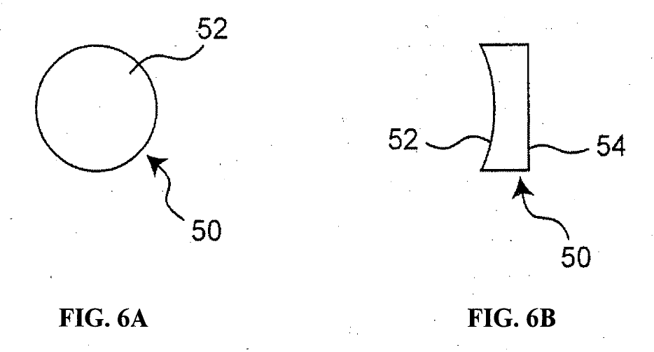

FIG. 3 is a schematic view explaining the optical glass element forming method according to one embodiment. FIG. 4 is a sectional view schematically illustrating a state just before forming in the forming method in FIG. 3. FIG. 5 is a perspective view schematically explaining a die in the forming method shown in FIG. 3 according to another embodiment. FIG. 6 illustrates the optical glass element obtained by the forming method shown in FIG. 3. FIG. 6A is a plan view of the optical glass element, and FIG. 6B is a side view of the optical glass element.

As a preform 40 to be used for the press molding, a glass body having a predetermined shape such as a pillar shape or a rectangular solid shape, for example, is prepared. Upper and lower surfaces of the preform 40 to be formed are polished into plain surfaces.

An upper die 10 has a forming surface 12 where three dome-shaped partially cylindrical convex surfaces such that side peripheral surfaces of a cylinder body is partially cut are arranged in parallel. The lower die 20 has a plane forming surface 22.

As shown in FIG. 5, the upper die 10 can be composed of a retaining block 18 having an approximately U shape, three dome-shaped die block bodies 14 arranged in the retaining block 18, and right and left die tightening jigs 16 which are arranged so as to nip the three semicircular die block bodies 14 from their sides.

A locating member 30 is obtained by forming a plurality of locating holes 34 on a flat retaining substrate 32, and the locating holes 34 are aligned lengthwise and crosswise (matrix pattern). The locating holes 34 have a dimension such that the locating holes 34 receive the preforms 40. The thickness of the retaining substrate 32 is set so as to be smaller than the thickness of the preform 40, and the retaining substrate 32 has a dimension such that the forming surface 12 of the upper die 10 does not touch the retaining substrate 32 at the time of the press molding.

A heater as a heating unit and a press cylinder as a pressurizing unit are disposed on non-forming surfaces of the upper die 10 and the lower die 20, respectively. A control unit that controls a heating operation, a cooling operation and a pressurizing operation of the upper die 10 and the lower die 20 is provided.

Heat-resistant materials such as ceramic, hard metal, carbon and metal can be used for the die set 1, which is composed of the upper die 10, the lower die 20 and the locating member 30, but carbon and ceramic which have satisfactory heat conductivity and low reactivity to glass are preferable.

A method of press molding the optical glass element 50 using the die set 1 having such a constitution is explained below.

The upper die 10 where a plurality of partially cylindrical convex surfaces is arranged in parallel on the forming surface 12, and the lower die 20 whose forming surface 22 is plane are prepared. The locating member 30 is arranged on the lower die 20, and the preforms 40 processed into a predetermined shape are supplied to the locating holes 34, respectively.

The upper die 10 and the lower die 20 are heated to a predetermined temperature, and the preforms 40 retained by the locating member 30 are hot-press-molded for predetermined time between the upper die 10 and the lower die 20. When the press molding is completed, the upper die 10 and the lower die 20 are cooled to a predetermined temperature. After the cooled upper die 10 and lower die 20 are separated, the optical glass elements 50 are taken out from the locating holes 34 of the locating member 30. The obtained optical glass elements 50 are measured whether they have predetermined optical properties. According to the forming process, a lot of optical glass elements 50 are obtained by one-time press molding, so that the production cost of the optical glass elements 50 can be greatly reduced.

### EXAMPLE

As shown in FIG. 6, as one example of the preferred optical glass element 50 of the present invention, a cylindrical lens where a formed upper surface 52 is a concave surface and a formed lower surface 54 is a plane is explained. In the cylindrical lens, for example, its diameter is 2.4 mm, its thickness of 0.8 mm, a curvature radius of its concave surface is 21.7 mm and a recessed amount of the concave surface is 0.033 mm. That it to say, the cylindrical lens has a very minute shape, and thus has a shape where centering and edging are practically impossible.

In order to press-mold the cylindrical lens having the above shape, the preform 40 of glass type SF57 which has a pillar shape where a diameter is 2.4 mm, a thickness is 0.8 mm and both surfaces are plane was prepared. The preform 40 was mounted into totally nine locating holes 34 three of which were arranged lengthwise and three of which were arranged crosswise. The three dome-shaped die block bodies 14 composing the upper die 10 have the convex forming surface 12 whose curvature radius is 21.7 mm. The forming surface 22 of the lower die 20 is a plane.

The upper die 10 and the lower die 20 were heated to 400° C., and a pressure of 50 kN/m² was applied thereto so that nine preforms 40 were press-molded simultaneously. When the surface shapes of the nine cylindrical lenses obtained by the press molding were measured, the surface accuracy was λ/6 or more, and they have less forming irregularity. The recessed amount of the formed upper surfaces 52 of the cylindrical lenses was 0.033 mm, a pushing amount at the time of the press molding was minute, and an outline did not fluctuate between the preform 40 and the formed optical glass element 50.

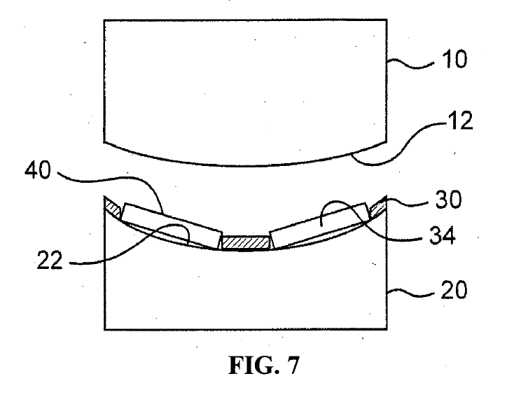

The present invention is not limited to the above embodiment, and as shown in FIG. 7, the present invention can be applied also to the case where optical elements such as lenses and mirrors which do not have an axially symmetrical optical axis, namely, are axially asymmetrical are manufactured. That is to say, in FIG. 7, the locating member 30 having the plural locating holes 34 in two rows is arranged between the upper die 10 having the convex partially cylindrical forming surface 12 and the lower die 20 having the concave partially cylindrical forming surface 22. After the preforms 40 are mounted into the locating holes 34, respectively, the preforms 40 are hot-press-molded between the upper die 10 and the lower die 30. As a result, a lot of optical elements which are axially asymmetrical can be manufactured by one-time press molding.

According to the above method, in the state that the preforms are set in the locating holes of the locating member arranged on the lower die, a pair of the upper die and the lower die having the forming surfaces corresponding to optical glass elements hot-press-mold the preforms. As a result, a lot of optical glass elements can be press-molded simultaneously. Since a post processing step such as cutting is not required after the press molding, the production cost can be reduced. Since the preforms are retained in the corresponding locating holes, respectively, occurrence of the forming irregularity is repressed, and thus the optical glass elements with less variation can be obtained.

In the above method, the forming surface of the upper die has a shape such that a plurality of partially cylindrical surfaces is arranged in parallel, the forming surface of the lower die has a plane shape, and the plural locating holes are aligned separately into a matrix pattern so as to correspond to the partially cylindrical surfaces.

This method can obtain a plurality of optical glass elements as the cylindrical lenses where one surface is a cylindrical surface and the other surface is a plane at a time.

According to the above method, when the plural dome-shaped die block bodies are arranged in parallel, the upper die which has the forming surface obtained by connecting the partially cylindrical convex surfaces can be formed, thereby reducing the production cost of the die.

When the cylindrical lenses where one surface is the cylindrical surface and the other surface is the plane are produced, the preforms whose upper and lower surfaces are formed into planes are used so that the production cost of the preforms can be reduced.

In order to suppress the outline fluctuation of the preforms due to the press molding. It is preferable that the pushing amount at the time of the press molding is very small.

In the above embodiment, the locating member is separated from the lower die. The locating member and the lower die may be integral, but they are desirably separated from each other. The forming surface of the lower die requires high accuracy, but the surface which comes in contact with the preform in the locating member requires less accuracy than the forming surface of the lower die. It is, therefore, desirable that the locating member is manufactured separately from the lower die by a method different from the method of manufacturing the lower die. Further, it is desirable that the locating member is separated from the lower die because only the locating member can be replaced or only the lower die can be replaced. The lower die is provided with the heater, but when a heater is not provided to the locating member, the operation for replacing the locating member can be simplified. The cost of the locating member can be held down.

Although the present invention has been fully described by way of examples with reference to the accompanying drawings, it is to be noted that various changes and modifications will be apparent to those skilled in the art. Therefore, unless such changes and modification depart from the scope of the present invention, they should be construed as being included therein.

What is claimed is:

1. A method of hot-press-molding a preform between a pair of an upper die and a lower die so as to manufacture an optical glass element, the method comprising the steps of:
arranging a locating member having a plurality of locating holes for locating the preform on the lower die;
supplying the preforms to the locating holes, respectively; and
hot-press-molding the preform between the paired upper die and the lower die.

2. The manufacturing method according to claim 1, wherein a forming surface of the lower die is a plane.

3. The manufacturing method according to claim 2, wherein a forming surface of the upper die has a shape such that a plurality of partially cylindrical surfaces is arranged in parallel.

4. The manufacturing method according to claim 3, wherein the plural locating holes are arranged separately into a matrix pattern so as to correspond to the partially cylindrical surfaces.

5. The manufacturing method according to claim 3, wherein the upper die is constituted so that a plurality of die block bodies having a partially cylindrical forming surface is arranged in parallel.

6. The manufacturing method according to claim 2, wherein both upper surface and lower surface of the preform are formed into planes.

8. The manufacturing method according to claim 1, wherein a pushing amount at the time of press molding is very small.

9. An optical glass element manufacturing apparatus, comprising:
a lower die;
a locating member which has a plurality of locating holes for locating preforms and is arranged on the lower die; and
an upper die which hot-press-molds the preforms between the lower die between the lower die and the upper die.

10. The manufacturing apparatus according to claim 9, wherein a forming surface of the lower die is a plane.

11. The manufacturing apparatus according to claim 10, wherein a forming surface of the upper die has a shape such that a plurality of partially cylindrical surfaces is arranged in parallel.

12. The manufacturing apparatus according to claim 11, wherein the plural locating holes are arranged separately into a matrix pattern so as to correspond to the partially cylindrical surfaces.

13. The manufacturing apparatus according to claim 11, wherein the upper die is constituted so that a plurality of die block bodies having partially cylindrical forming surfaces is arranged in parallel.

14. The manufacturing apparatus according to claim 10, wherein both upper surface and lower surface of the preform are formed into planes.
